(19) United States
(12) Patent Application Publication
(10) Pub. No.: US 2002/0145293 A1
(43) Pub. Date: Oct. 10, 2002

(54) Exterior vehicle body protector

(76) Inventor: Greg Bond, Burbank, CA (US)

Correspondence Address: GREG BOND, P.O. BOX 446, WOODLAND HILLS, CA, 91365, US

(21) Appl. No.: 09/832,145

(22) Filed: Apr. 10, 2001

(51) Int. Cl. B60R 19/42

(52) U.S. Cl. 293/128

(57) ABSTRACT

The invention is distinguishable from prior similar inventions in that it consists of a removable, flexible, lightweight, protective rubber shield with magnetic backing.

### CROSS-REFERENCE TO RELATED APPLICATIONS

A second Utility Patent Application for a similar invention, titled “BULLET RESISTANT EXTERIOR VEHICLE BODY PROTECTOR,” to be used particularly on law enforcement vehicles, or other vehicles needing protection from gunfire, is submitted concurrently with this application.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

This invention relates to vehicle body protection. It is used to protect a vehicle's body from or against nicks, scratches, bumps, chips etc. that may be caused by other vehicles, persons, objects or the elements. The inventor considers it to be useful and an improvement over prior similar inventions.

Prior inventions in the nature of exterior vehicle protectors, door guards and the like are considered by the inventor to be bulky, awkward, heavy, not easily attached or removed from a vehicle and expensive to manufacture.

### BRIEF SUMMARY OF THE INVENTION

The object of the invention is to provide the user with an exterior vehicle body protector which is lightweight, flexible, easily attached and removed from a vehicle and inexpensive to manufacture. The inventor believes his invention accomplishes that object.

### BRIEF DESCRIPTION OF THE SEVERAL VIEWS OF THE DRAWING

FIG. 1 is a front elevational view of the car exterior protector showing my new design;

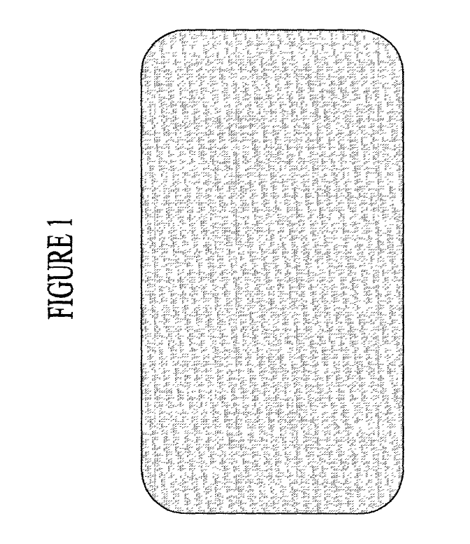

FIG. 2 is a rear elevational view thereof;

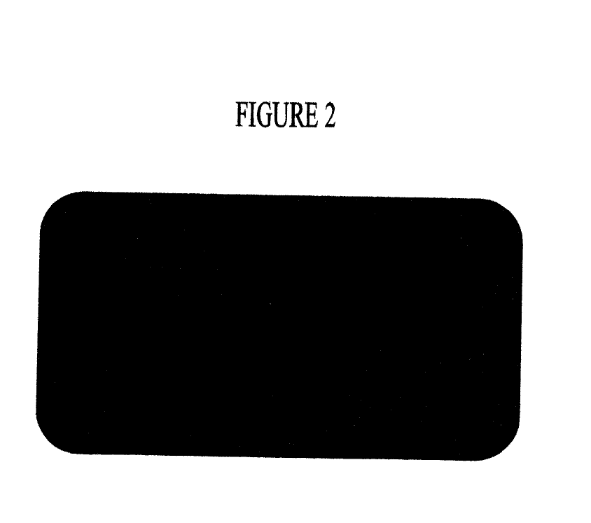

FIG. 3 is a left side elevational view thereof;

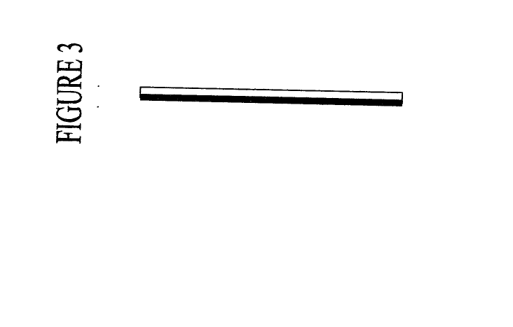

FIG. 4 is a right side elevational view thereof;

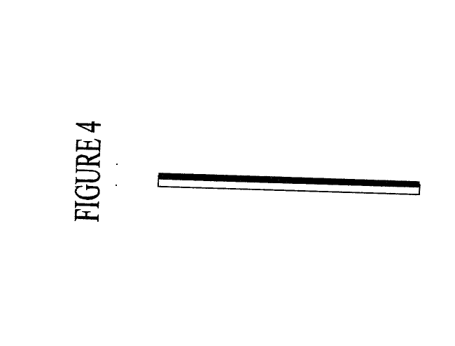

FIG. 5 is a top plan view thereof; and

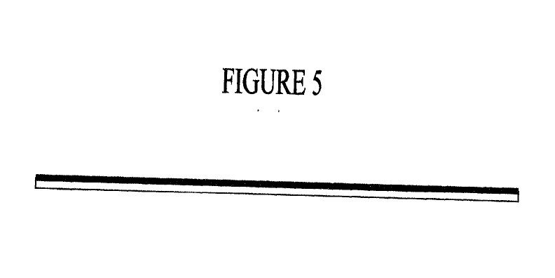

FIG. 6 is a bottom plan view thereof

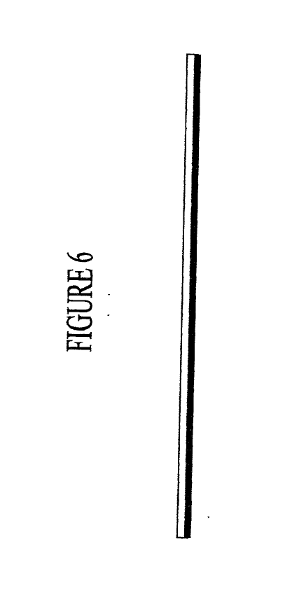

### DETAILED DESCRIPTION OF THE INVENTION

This invention is an exterior vehicle body protector which consists of a removable, flexible, lightweight, protective rubber shield with magnetic backing. The foregoing characteristics distinguish it from prior inventions created for the same purpose. The item is manually placed on either or both exterior sides of that portion of a vehicle which encloses the front and rear seat compartments (below the side windows and between the front and rear quarter panels).

1. What I claim as my invention is a vehicle exterior protector consisting of a removable, flexible, lightweight, protective rubber shield with magnetic backing that will protect a vehicle from or against nicks, scratches, bumps, chips etc. that may be caused by other vehicles, persons, objects or the elements.
